(19) United States
(12) Patent Application Publication
(10) Pub. No.: US 2024/0220636 A1
(43) Pub. Date: Jul. 4, 2024

(54) SECURITY DESIGN FLAW DETECTION METHOD BASED ON UNIT TEST CASE, RECORDING MEDIUM AND DEVICE FOR PERFORMING THE SAME

(71) Applicant: Foundation of Soongsil University-Industry Cooperation, Seoul (KR)

(72) Inventors: Jeong Hyun YI, Seoul (KR); Haehyun CHO, Seoul (KR); Kyungmin SIM, Incheon (KR); Sunjun LEE, Seoul (KR); Geochang JEON, Seoul (KR)

(73) Assignee: Foundation of Soongsil University-Industry Cooperation, Seoul (KR)

(21) Appl. No.: 18/550,865

(22) PCT Filed: Oct. 12, 2022
(86) PCT No.: PCT/KR2022/015342

§ 371 Date: Sep. 15, 2023

(30) Foreign Application Priority Data
Nov. 25, 2021 (KR) 10-2021-0164903
Jan. 4, 2022 (KR) 10-2022-0000934

(51) Int. Cl. G06F 21/57

(52) U.S. Cl. CPC G06F 21/577; G06F 2221/033

(57) ABSTRACT

Provided is a unit test case-based security design flaw detection method performed in a security design flaw detection apparatus for detecting a security design flaw of a software system, and the method comprises collecting a unit test case for the software system from an external device and preprocessing the unit test case; generating a first test case by testing whether the software system violates a security policy using the preprocessed unit test case; generating a second test case that is a data set for testing a function of the software system based on the first test case; and detecting a vulnerability of the software system by executing the second test case.

### TECHNICAL FIELD

The present invention relates to a security design flaw detection method based on unit test cases, a recording medium and an apparatus for performing the same, and more particularly, it relates to a security design flaw detection method based on unit test cases that can help to evaluate security vulnerabilities that may occur due to unrestricted and misimplemented behaviors of software systems.

### BACKGROUND ART

As the IoT market continues to grow, the number of IoT devices is expected to increase each year to 25 billion by 2021. In this environment, as the importance of mobile devices increases, the market for mobile applications is also growing rapidly.

However, security vulnerabilities due to design flaws in software systems continue to appear in real systems, and these security design flaws can cause unrestricted and incorrect system operation, leading to critical vulnerabilities such as remote code execution or sensitive data leakage.

Detecting unrestricted and incorrect behavior of these systems is an essential task, but detailed analysis of the entire code is time-consuming and error-prone, making it difficult for security experts to discover these vulnerabilities in advance.

In general, these security vulnerabilities can be mainly caused by memory corruption errors such as out-of-bounds memory access or use of uninitialized memory, and security design flaws.

Specifically, memory corruption errors such as buffer overflow, out-of-bound access, use-after-free, and double-free are significant security issues affecting programs developed in unsafe languages (such as C and C++). The majority of memory corruption errors are caused by programming errors, and these errors occur frequently due to the size and complexity of actual software. Thus, by exploiting the vulnerability, a hacker (attacker) can change the address to execute a piece of malicious code or access sensitive data in memory. These memory corruption errors have remained at the top of dangerous software vulnerabilities for the past 27 years and rank fifth in the top 25 most dangerous software vulnerabilities of 2020.

Besides, design flaws can be a serious security threat to many users. The following are actual examples of security threats.

First, the Apache Struts framework, which is used for Java web application development based on the MVC framework, has serious vulnerabilities because it cannot control unrestricted operations in this framework. The Apache Struts framework supports Object-Graph Navigation Language (OGNL) expressions used to get or set the property values of Java objects, and can execute OGNL expressions received in HTTP requests. Therefore, because OGNL expressions can access internal objects containing sensitive data in the system, their execution has to be carefully controlled.

Unfortunately, the Apache Struts framework lacks such a control mechanism, which leads to many serious vulnerabilities that allow arbitrary code execution. Thus, hackers exploited these vulnerabilities by inserting exploit code into HTTP request tags through leaking credential files using OGNL expressions or opening backdoors. FIG. 1 shows a partial list of vulnerabilities that can be exploited to execute arbitrary code in Apache Struts. As can be seen from the average CVSS score (8.3), the severity is very high, and 23 of them allow hackers to execute code remotely. These vulnerabilities found in Apache Struts clearly show that unrestricted operation of software due to design flaws can lead to serious security vulnerabilities.

Secondly, Shellshock is a vulnerability found in the Unix Bash shell that allows hackers to gain unauthorized access and execute arbitrary code through a vulnerability that allows the execution of arbitrary commands in environment variables that should not be used since it has a vulnerability that can execute arbitrary commands. Hackers started exploiting the Shellshock vulnerability hours after the initial disclosure, and millions of actual hacks related to the vulnerability were recorded in just a few days.

Table 2 is a list of vulnerabilities related to Shellshock and their severity. This second example demonstrates that a design flaw can be a significant cybersecurity threat affecting millions of users. In particular, the fact that it took 22 years from the first release of the version of Bash affected by these vulnerabilities to the discovery of the vulnerabilities is an example showing that evaluating design flaws from a security perspective is very important and is essential to eliminating potential cybersecurity threats.

Finally, Heartbleed is a serious security vulnerability in the OpenSSL encryption software library, which provides Secure Sockets Layer/Transport Layer Security (SSL/TLS) encryption used for internet security. Exploitation of this vulnerability could read 64 KB of memory because it does not check whether the length of the payload matches the payload contained in the Heartbeat request message.

Thus, Heartbeat allows TLS and Datagram Transport Layer Security (DTLS) protocols to maintain communication connections without having to renegotiate the connection each time. And, when the server responds to the Heartbeat, it returns the length of the payload received as requested in memory. Therefore, sensitive information such as private keys stored in the system memory can be leaked, and this security design flaw has left many websites vulnerable.

In this regard, automated vulnerability detection methods comprise fuzzing, symbolic execution, and taint analysis. However, most of the existing automated vulnerability detection approaches and methods stop at discovering memory vulnerabilities in programs that cause logic defects or memory corruption in programs, so effective methods for detecting vulnerabilities due to security design flaws are needed.

### DISCLOSURE

### Technical Problem

The present invention has been made to solve the above problems, and an object of the present invention is to provide a unit test case-based security design flaw detection method capable of detecting security vulnerabilities due to security design flaws that may occur due to unrestricted and misimplemented behaviors of a software system, and to provide a recording medium and apparatus for performing the same.

### Technical Solution

In order to achieve the above object, according to an embodiment of the present invention, a unit test case-based security design flaw detection method performed in a security design flaw detection apparatus for detecting a security design flaw of a software system comprises collecting a unit test case for the software system from an external device and preprocessing the unit test case; generating a first test case by testing whether the software system violates a security policy using the preprocessed unit test case; generating a second test case that is a data set for testing a function of the software system based on the first test case; and detecting a vulnerability of the software system by executing the second test case.

Further, preprocessing the unit test case may comprise preprocessing the unit test case by classifying code snippets included in the unit test case, and combining or changing the unit test case based on the classified code snippets.

Further, generating the first test case may comprise performing a first security policy test to identify whether authorization is granted through an access control check on the preprocessed unit test case; performing a second security policy test to identify whether data has been changed or tampered without authorization through an integrity check on the preprocessed unit test case; and performing a third security policy test to identify whether data is encrypted through a confidentiality check on the preprocessed unit test case.

Here, the first security policy test, the second security policy test, and the third security policy test may be performed according to a preset order.

Further, generating the second test case may comprise generating the second test case by manipulating the first test case with a randomly generated data type and value, or generating the second test case by combining an unpreprocessed unit test case with the first test case.

In order to achieve the above object, according to an embodiment of the present invention, a computer program for performing the unit test case-based security design flaw detection method is recorded in a computer-readable storage medium.

In order to achieve the above object, according to an embodiment of the present invention, a unit test case-based security design flaw detection apparatus for detecting a security design flaw of a software system comprises a preprocessing unit for collecting a unit test case for the software system from an external device and preprocessing the unit test case; a security policy test unit for generating a first test case by testing whether the software system violates a security policy using the preprocessed unit test case; a test case generation unit for generating a second test case that is a data set for testing a function of the software system based on the first test case; and a vulnerability detection unit for detecting a vulnerability of the software system by executing the second test case.

Further, the preprocessing unit may preprocess the unit test case by classifying code snippets included in the unit test case, and combining or changing the unit test case based on the classified code snippets.

Further, the security policy test unit may comprise an access control check unit for performing a first security policy test to identify whether authorization is granted through an access control check on the preprocessed unit test case; a data integrity verification unit for performing a second security policy test to identify whether data has been changed or tampered without authorization through an integrity check on the preprocessed unit test case; and a data confidentiality unit for performing a third security policy test to identify whether data is encrypted through a confidentiality check on the preprocessed unit test case.

Here, the first security policy test, the second security policy test, and the third security policy test may be performed according to a preset order.

Further, the test case generation unit may comprise a random generation unit for generating the second test case by manipulating the first test case with a randomly generated data type and value; and a combination generation unit for generating the second test case by combining an unpreprocessed unit test case with the first test case.

### Advantageous Effects

According to one aspect of the present invention described above, by providing a security design flaw detection method based on unit test cases, a recording medium and an apparatus for performing the same, it is possible to detect security vulnerabilities due to security design flaws that may occur due to unrestricted and misimplemented behaviors of software systems.

### DESCRIPTION OF DRAWINGS

These and/or other aspects will become apparent and more readily appreciated from the following description of the embodiments, taken in conjunction with the accompanying drawings which:

FIGS. 1 and 2 are diagrams describing security vulnerabilities due to design flaws;

FIG. 3 is a diagram describing the configuration of a security design flaw detection apparatus 100 according to an embodiment of the present invention;

FIG. 4 is a diagram describing the detailed configuration of a security design flaw detection apparatus 100 according to an embodiment of the present invention;

FIGS. 5 and 6 are diagrams for describing test cases generated by the security design flaw detection apparatus 100 according to the present embodiment;

FIGS. 7 and 8 are diagrams describing a process of detecting a vulnerability in the security design flaw detection apparatus 100 according to the present embodiment;

FIG. 9 is a diagram describing the types of vulnerabilities detected by the security design flaw detection apparatus 100 according to the present embodiment; and

FIG. 10 is a flowchart illustrating a security design flaw detection method according to an embodiment of the present invention.

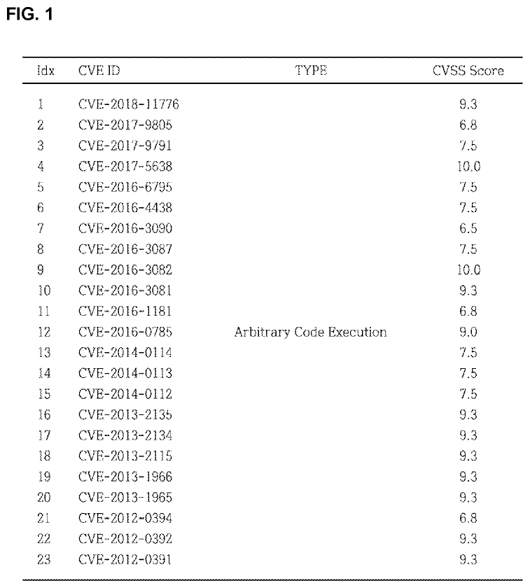

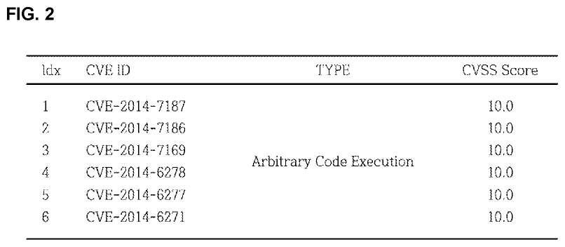

### DETAILED DESCRIPTION OF EMBODIMENTS

The detailed description of the present invention which follows refers to the accompanying drawings which illustrate, by way of illustration, specific embodiments in which the present invention may be practiced. These embodiments are described in sufficient detail to enable those skilled in the art to practice the present invention. It should be understood that the various embodiments of the present invention are different from each other but are not necessarily mutually exclusive. For example, specific shapes, structures, and characteristics described herein may be implemented in another embodiment without departing from the spirit and scope of the invention in connection with one embodiment. Additionally, it should be understood that the location or arrangement of individual components within each disclosed embodiment may be changed without departing from the spirit and scope of the invention. Accordingly, the detailed description set forth below is not to be taken in a limiting sense, and the scope of the present invention, if properly described, is limited only by the appended claims, along with all equivalents as claimed by those claims. Like reference numbers in the drawings indicate the same or similar function throughout the various aspects.

In addition, the components according to the present invention are components defined not by physical division but by functional division, and may be defined by the functions that each performs. Each component may be implemented as hardware or program codes and processing units that perform respective functions, and functions of two or more components may be included in one component and implemented.

Therefore, the names given to the components in the following embodiments are not to physically distinguish each component, but to imply the representative function performed by each component, and it should be noted that the technical idea of the present invention is not limited by the names of the components.

Hereinafter, preferred embodiments of the present invention will be described in more detail with reference to the drawings.

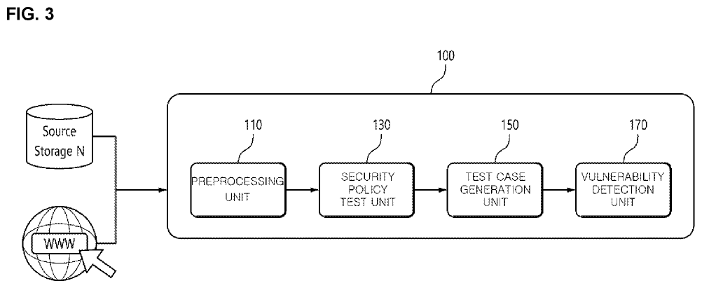

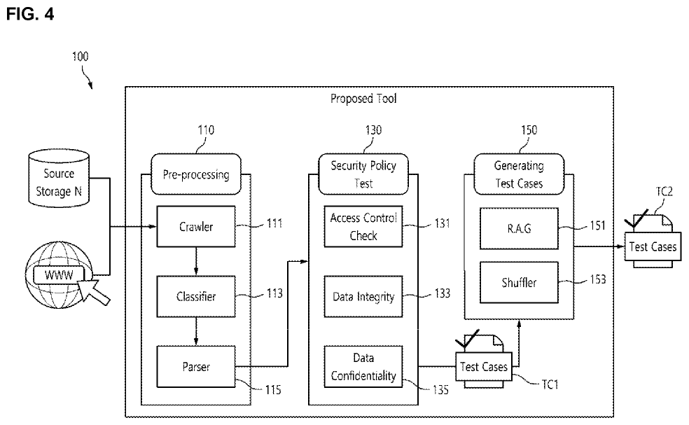

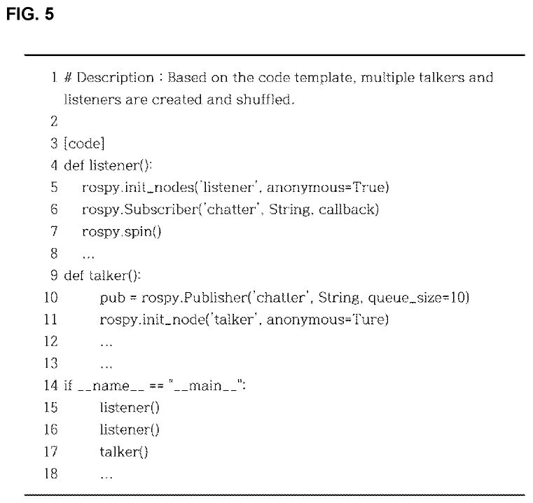

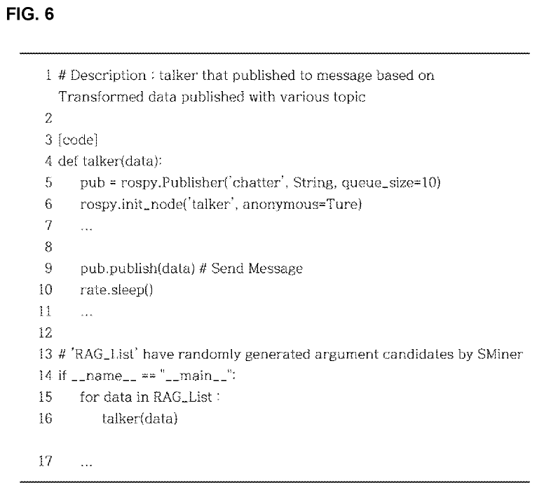

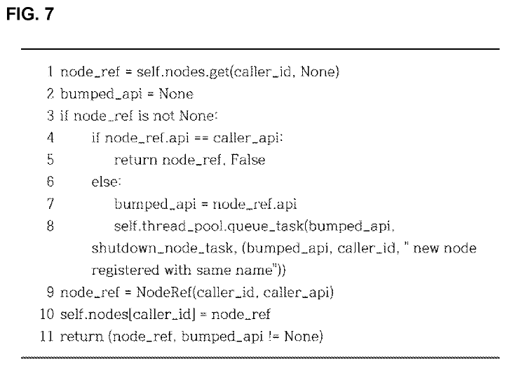

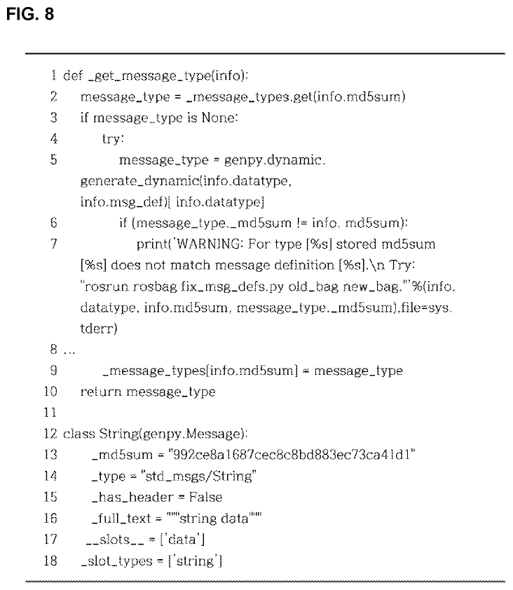

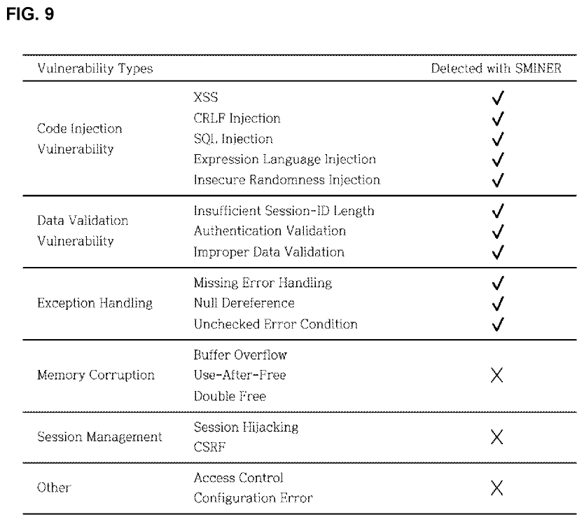

FIG. 3 is a diagram for describing the configuration of a security design flaw detection apparatus 100 according to an embodiment of the present invention, FIG. 4 is a diagram for describing a detailed configuration of the security design flaw detection apparatus 100 according to an embodiment of the present invention, FIGS. 5 and 6 are diagrams for describing test cases generated by the security design flaw detection apparatus 100 according to the present embodiment, FIGS. 7 and 8 are diagrams for describing a process of detecting a vulnerability in the security design flaw detection apparatus 100 according to the present embodiment, and FIG. 9 is a diagram for describing types of vulnerabilities detected by the security design flaw detection apparatus 100 according to the present embodiment.

As described above, unauthorized operations can be performed due to security vulnerabilities in software. The most common security vulnerabilities are caused by memory corruption bugs, and these bugs can be caused by programmer mistakes and source code errors.

These bugs, which can lead to security vulnerabilities, can break a program, so ideally they can be found during software development and testing, and, as mentioned above, do not affect the functionality of the software, but design flaws that can cause incorrect, unexpected or unintended behavior can lead to serious security vulnerabilities, such as remote code execution, endangering millions of users. In particular, these vulnerabilities are difficult to detect due to the absence of an automated assessment tool, and accordingly, security flaws, such as the Shellshock case described above, may not be discovered for a very long time.

In particular, these unit test cases implemented by developers are often implemented without considering the security aspect. For example, if there is code that causes an error but it properly works unintentionally, or if it seems to be working properly but actually causes an error, it can lead to system vulnerabilities.

Accordingly, the apparatus 100 for detecting security design flaws according to an embodiment of the present invention may be provided to detect security vulnerabilities based on unrestricted and misimplemented behaviors of a system. The apparatus 100 for detecting security design flaws according to the present embodiment may evaluate vulnerabilities through security policies using test cases of target programs.

At this time, the apparatus 100 for detecting security design flaws defines two abnormal behaviors of the software system that can be caused by design flaws. One may be an unrestricted behavior, which is a behavior that is not limited, and the other may be a misimplemented behavior.

Here, the unrestricted behavior, that is, a behavior that is not limited may occur when the system appropriately restricts or does not restrict the operation requested by itself or externally. Specifically, for example, SQL injection can lead to serious data breaches by maliciously injecting and executing arbitrary SQL queries to manipulate databases into behaving abnormally, which is a vulnerability caused by not properly checking allowed input types and values.

Meanwhile, the misimplemented behavior may be a result of an incorrect or improperly implemented function from a security point of view. In the present invention, the focus is on detecting the misimplemented behavior due to improper implementation. This could be the case, for example, when a program encrypts wrong data (other than the data it needs to encrypt) when it performs encryption operations with the misimplemented behavior.

The security design flaw detection apparatus 100 of the present invention, which detects security vulnerabilities based on such unrestricted behaviors and misimplemented behaviors, can automatically generate complex and ambiguous test cases based on the unit test cases of the system implemented by the developer. In general, the unit test cases can contain code that should work correctly as expected, rather than code that creates errors.

Therefore, the security design flaw detection apparatus 100 for detecting vulnerabilities in the software system of the present invention can detect undefined and misimplemented behaviors in the target software system through automatically generated test cases.

To this end, in the security design flaw detection apparatus 100, software (application) for performing a security design flaw detection method may be installed and executed, and a preprocessing unit 110, a security policy test unit 130, and a test case generation unit 150 and a vulnerability detection unit 170 may be provided.

The preprocessing unit 110 may collect unit test cases, which are codes previously implemented by a developer for a software system stored in an external device, from an external device and preprocess the collected unit test cases. Here, the preprocessing may be preprocessing the unit test cases by classifying code snippets included in the collected unit test cases and combining or changing the classified code snippets. To this end, the preprocessing unit 110 may comprise a crawler 111, a classifier 113, and a parser 115.

The crawler 111 can collect unit test cases for target software systems from external devices such as official repositories including web pages and the like over the network, and in general, most software systems include unit test cases, which are basic code snippets for testing each function.

In addition, since the crawler 111 needs to use the corresponding information after collecting the unit test cases, it can also collect information on the code source, such as the URL where the unit test case is located and the path where it is stored inside the source repository. For example, assuming that the code template is imported via “https://github.com/ros/ros_tutorials/tree/noetic-devel/rospy_tutorials/001_talker_listener/talker.py,” in this case, it can be seen from the URL that the code template is targeting the noetic version of ROS and is a unit test to test functionality between the talker and the listener from the talker's point of view.

Besides, the classifier 113 may classify the code snippets collected by the crawler 111 into classes, functions, annotations, and variables. Then, the classified code snippets may be delivered to the parser 115.

Besides, the parser 115 may combine or change code snippets, that is, unit test cases, which are data classified by the classifier 113 to generate test cases for discovering unrestricted and misimplemented behaviors of the target software system.

Here, the parser 115 modifies and preprocesses the intuitively recognizable function of each unit test case, rather than analyzing the logical flow or meaning of each unit test case, so that the operation of the target software system can be identified. For example, if a function is called using a specific variable in a unit test case, the parser 115 may randomly modify the value of the variable by generating a test case that calls the corresponding function. Annotations for each unit test case may also be provided to the user to indicate the intended function of the target software system. Based on this information, users can find the intended function of the target software system without manually analyzing the target software system or unit test cases.

In this case, since the parser 115 cannot provide enough information to the user in poorly developed unit test cases that do not have adequate descriptions to describe the function under test, the parser 115 may provide only information such as function names or unit test cases to the user.

In this way, the preprocessed unit test cases, which are data obtained by combining or changing unit test cases in the parser 115, may be delivered to the security policy test unit 130.

Besides, the security policy test unit 130 may generate a first test case TC1 by testing whether the target software system violates the security policy using the unit test case preprocessed by the preprocessing unit 110. In practice, any security policy is tightly coupled to system functionality, and functional testing involves the execution of many security mechanisms.

However, since the test function implemented by the developer does not consider the test security aspect, but security vulnerabilities can affect the usability of the application, the security policy can provide sufficient confidence in the security mechanism.

In most cases, since the distribution of security policies is not automated, it is necessary to check or test the correctness of the implementation. In this context, through the security policy test performed by the security policy test unit 130 of the present invention, it is possible to obtain evidence that the implementation of the security policy for the security policy required for the corresponding software system is accurate.

Therefore, the security policy test unit 130 according to the present invention can show the security policy that can occur from the security point of view of the target software system by using the preprocessed unit test cases, and the user can understand and check whether the target software system is properly implemented through the security policy.

There are a wide variety of categories to which security policies are applied in the target software system. In the security design flaw detection apparatus 100 according to the present embodiment, among the characteristics of the system, data transmission security is focused, and security problems that may occur due to unrestricted and misimplemented behaviors can be prevented in advance.

The data security policy determines the types of operations permitted to users with access rights and to each user of the entity, and, based on this, the security policy test unit 130 of the present invention may comprise an access control check unit 131, an integrity verification unit 133, and a data confidentiality unit 135.

First, the access control check unit 131 may perform a first security policy test to identify whether authorization is granted through access control checks on the preprocessed unit test cases. The access control check unit 131 may identify detailed security or authorization functions such as role-based access to functions of the target software system, user access rights, and function partitioning. Accordingly, the access control check unit 131 may perform a first security policy test to identify whether functions such as administrator authorization and authorization elevation operating in the target software system are granted authorization through control.

The data integrity verification unit 133 may perform a second security policy test to identify whether data has been changed or tampered without authorization through an integrity check on the preprocessed unit test cases. Data should be protected from unauthorized change or tampering, and data integrity can protect against the security risk of tampering with unauthorized information interception and change. In addition to protecting the data stored within the network, this data integrity requires an additional security element to ensure data integrity when untrusted data is transmitted to the system. When data entering the system is received on a public network, it should be protected from sniffing and interpretation, usually by encryption, and it should be ensured that the data has not been changed. To this end, the data integrity verification unit 133 may perform a second security policy test to identify whether data has been changed or tempered.

Moreover, the data confidentiality unit 135 may perform a third security policy test to identify whether data is encrypted through a confidentiality check on the preprocessed unit test cases. Data confidentiality means that information is disclosed only to authorized users, and the contents of transmitted data are completely protected to prevent unauthorized users, that is, unauthorized persons from accessing the actual contents of the information. Confidentiality, which is guaranteed to be confidential and can prevent the unwanted disclosure of information, can mainly protect data from acts related to data hijacking, and can identify whether encryption is used, which is the most popular method of use. The data confidentiality unit 135 may perform a third security policy test to identify whether data is encrypted.

At this time, the security design flaw detection apparatus 100 may cause the first security policy test performed by the access control check unit 131, the second security policy test performed by the data integrity verification unit 133, and the third security policy test performed by the data confidentiality unit 135 to be performed according to a preset order. This preset order may be an order set by a system developer using the security design flaw detection apparatus 100, and the security policy test unit 130 may sequentially perform the first to third security policies according to the set order. In FIG. 4, the third security policy test performed by the data confidentiality unit 135 is shown to be performed last, but this is merely an example for convenience of description, and is not limited thereto.

In addition, the first test case TC1, which is a preprocessed unit test case, in which all security policy tests are completed, may be delivered to the test case generation unit 150 together with the result of the security policy test. The result of the security policy test may also be included in the first test case TC1.

Besides, the test case generation unit 150 may generate a second test case TC2, which is a data set for testing the function of the target software system based on the first test case TC1 delivered from the security policy test unit 130.

At this time, in generating the second test case TC2 using the test case generation unit 150, the security policy that may be violated in the target software system is applied to the first test case TC1 to generate the second test case.

In addition, in order to maximize the possibility of discovering unrestricted and misimplemented behaviors, rather than generating a second test case TC2 capable of testing specific functions of the target software system, it may be desirable for the test case generation unit 150 to generate a second test case TC2 capable of testing various functions at once as shown in FIGS. 5 and 6. To this end, the test case generation unit 150 may comprise a random generation unit 151 and a combination generation unit 153.

A random generation unit (R.A.G) 151 may generate the second test case by manipulating the first test case with randomly generated data types and values.

Specifically, the random generation unit 151 changes the code snippets included in the first test case TC1 into randomly generated data types and values to manipulate the values (data) inside the unit test case, so that the second test case TC2 can be generated as a single unit test case.

Besides, the combination generation unit 153 may generate the second test case TC2 by combining the unpreprocessed unit test case with the first test case TC1.

In particular, the combination generation unit 153 may generate the second test case TC2 by combining the unit test cases collected by the crawler 111, that is, a plurality of unit test cases that have not been preprocessed through the parser 115, into the first test case TC1.

At this time, the number of unpreprocessed unit test cases combined into the first test case TC1 may be arbitrarily determined or determined according to a preset number. Also, the combination generation unit 153 may allow the user to specify a unit test case to be combined with the first test case TC1.

Besides, the vulnerability detection unit 170 may detect system vulnerabilities by executing the second test case TC2 generated through the random generation unit 151 or the combination generation unit 153.

Although not shown in the drawings, the security design flaw detection apparatus 100 according to an embodiment of the present invention may comprise a communication unit or an input unit for collecting or receiving various necessary information including unit test cases, as well as a storage unit for storing various information necessary for preprocessing and analyzing the collected unit test cases to generate a test case, and an output unit for outputting the result.

Hereinafter, quantitative and qualitative evaluation results performed to check the effectiveness of the security design flaw detection apparatus 100 according to an embodiment of the present invention will be described. In order to verify the effectiveness of the security design flaw detection apparatus 100 according to the present embodiment, evaluation was performed on a system running Ubuntu Linux 14.06 64-bit equipped with a 3.40 GHz Intel Skylake processor and 16 GB RAM, and the security design flaw detection apparatus of the present invention was used to discover vulnerabilities in ROS (Robot Operating System) of various versions.

Here, ROS is an open-source meta-operating system (a collection of software frameworks) for robotics, and currently, ROS is used in many academic projects and commercial products. ROS can implement hardware abstraction, low-level device control, frequently used functions provided by general operating systems, and provide inter-process message delivering and package management functions. It also provides tools and libraries to work with multiple systems, and has a significant level of complexity, including distributed computation, multi-threading, event-driven programming, and other system core concepts.

Here, ROS proceeds through message communication between nodes, and nodes should register information with the master when starting. The master has the information of each node and plays an important role in managing the nodes. However, the master can also fail, and if unrestricted or misimplemented behavior occurs in the master, it can negatively affect the entire system. Remote mode execution vulnerabilities, including CVE-2016-10681, were also found in ROS, a representative meta OS for robots, and many MiR robots were exposed to vulnerabilities due to design flaws in the calculation graph package provided by ROS.

For evaluation, 13 versions of ROS were tested, starting with the first released BOX Turtle version and the most recently released ROS Noetic Nunjemys version.

ROS has several unit test cases designed to check interactions between basic functions, services, and nodes, and test cases were generated to discover unrestricted or misimplemented behaviors in these ROS using the security design flaw detection apparatus 100 of the present invention.

In order to detect vulnerabilities based on unrestricted and misimplemented behaviors in ROS, fuzzy test cases were generated as test cases using the security design flaw detection apparatus 100 according to the present embodiment, and they were executed in ROS and monitored.

First, the security design flaw detection apparatus 100 collected 113 unit test cases from the official source code repository and the ROS web community. Next, test cases for discovering vulnerabilities were generated, and FIGS. 5 and 6 are diagrams showing code snippets of test cases generated by the security design flaw detection apparatus 100. As shown in each drawing, the security design flaw detection apparatus 100 may provide a user with a brief description of modules evaluated in each test case.

As a result of the evaluation, the security design flaw detection apparatus 100 of the present invention detected vulnerabilities by identifying unrestricted behaviors and misimplemented behaviors in the XMLRPC module and TCPROS module of ROS in numerous generated test codes. In addition, it was confirmed that the detected vulnerabilities can be exploited from the first released ROS version to the latest version.

First, the unrestricted and unlimited behavior in the XMLRPC module will be described. FIG. 7 is a diagram showing the process of registering new information of a node in the master as described above, and an unrestricted behavior was detected by executing a test case registering a listener of the same name. In ROS, the Talker node and the Listener node should be registered in the master node to communicate with each other. In FIG. 5, a node named “listener” is initially registered with the master, another node named “listener” sends a registration request to the master, and it is found that the previously registered “listener” node is unregistered through the test case.

After manually analyzing the root cause of the vulnerability, a problem was found in the XMLRPC communication module used to initiate connections between nodes (e.g., talker and listener) in the master node. When the master node received a request from a talker and a node that wanted to become a talker, the master did not perform authentication procedures to register the node as a listener or talker.

FIG. 7 shows a code snippet for registering a new node in the XMLRPC module. When a registration request is received from a node, only the API value corresponding to the node address is checked. If the previous API value and the requested API value are different, the XMLRPC module sets the requested API to bumped_api without further confirmation. Therefore, if a new node with the same name as the previously registered node requests a listener, the existing service is canceled and a new connection is started. As a result, it shows that the malicious node in ROS can become a listener and intercept the data traffic between the two nodes.

Besides, misimplemented behaviors in the aforementioned TCPROS module will be described below. FIG. 8 is a diagram for checking md5sum and string message type codes used in ROS. The test case shown in FIG. 6, that is, the second test case generated by the security design flaw detection apparatus 100 is a test case, in which randomly generated arguments are sent to the talker node. As a result of executing the corresponding test case and monitoring the execution result, a misimplemented behavior was found in ROS, and the hash function for the message integrity check was not used properly.

In ROS, the TCPROS module is used to transmit messages and services based on TCP/IP, and the message header of all messages transmitted by the TCPROS module has an md5sum field to check message integrity. However, it was confirmed that the function to check message integrity was not carefully implemented in the TCPROS module. Specifically, FIG. 8 shows a function using the md5sum hash in the TCPROS module. In the function, instead of hashing the message body containing the actual data of the message, only the message type is hashed to generate the md5sum. Therefore, even if the message is different, the md5sum value of the message is the same, and as a result, ROS has a vulnerability where it is possible to forge each message without going through the verification process.

The types of vulnerabilities that the security design flaw detection apparatus 100 can discover were evaluated, and this evaluation provides a specific range that can help the security design flaw detection apparatus 100 detect vulnerabilities. The types of vulnerabilities that can be detected by the security design flaw detection apparatus 100 according to the present invention are as shown in FIG. 9. A check mark (v) in the drawing indicates a detectable vulnerability type.

Referring to FIG. 9, code injection vulnerability is when a malicious code can be inserted into a system to create a payload and be executed. This vulnerability exists when a program does not properly restrict or check input values. Accordingly, the security design flaw detection apparatus may generate test cases using predefined values or symbols used to cause such vulnerabilities.

Data validation vulnerability occurs when the function for verifying data type is incorrectly implemented, and the security design flaw detection apparatus 100 according to the present embodiment can generate a test case that intentionally causes improper use of a data type for the target software system as the second test case, and can generate a test case that executes several arbitrary functions in arbitrary order. These test cases can be used to discover a data validation vulnerability type because they can use or manipulate data structures that have arbitrary functionality not implemented for data structures.

On the other hand, exception-handling-type vulnerabilities exist when there is no proper exception-handling function implemented in the system. If an exception handler is not implemented in the system, exceptions can crash or lead to other vulnerabilities. Accordingly, the security design flaw detection apparatus 100 may generate and provide a test case using various data and a second test case capable of testing interactions between various functions of the system. This second test case may trigger an exception in the system, which may help detect vulnerabilities related to exception handling.

In summary, FIG. 9 shows that the security design flaw detection apparatus 100 according to the present embodiment can detect code injection, data verification, and exception handling type vulnerabilities. Therefore, it can be seen that, unlike conventional vulnerability detection apparatuses that stop at finding memory vulnerabilities, the security design flaw detection apparatus 100 of the present invention is effective in detecting vulnerabilities due to security design flaws.

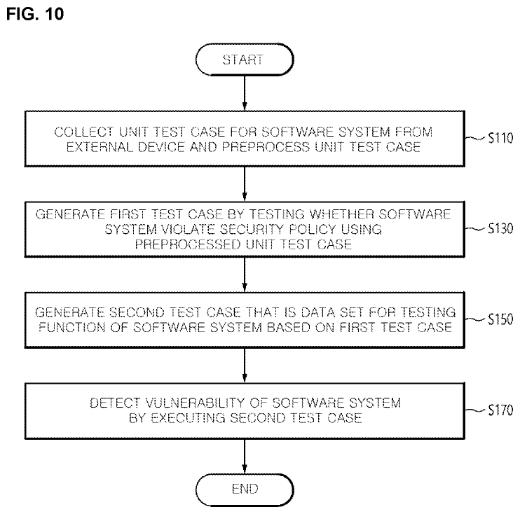

Meanwhile, FIG. 10 is a flowchart for describing a security design flaw detection method according to an embodiment of the present invention. Since the security design flaw detection method according to an embodiment of the present invention is carried out on substantially the same configuration as the security design flaw detection apparatus 100 for detecting security design flaws, the same reference numerals are given to the same components as the security design flaw detection apparatus 100 of FIGS. 3 and 4. and repeated descriptions will be omitted.

First, the security design flaw detection apparatus 100 may collect unit test cases for the software system from an external device and preprocess the unit test cases (S110).

In the preprocessing step (S110), the unit test case may be preprocessed by classifying code snippets included in the unit test case, and combining or changing the unit test case based on the classified code snippets.

Thereafter, the step of generating a first test case may be performed by testing whether the software system violates the security policy using the preprocessed unit test case (S130).

The step of generating the first test case (S130) may comprise the step of performing a first security policy test to identify whether authorization is granted through an access control check on the preprocessed unit test case (not shown), the step of performing a second security policy test to identify whether data has been changed or tampered without authorization through an integrity check on the preprocessed unit test case (not shown), and the step of performing a third security policy test to identify whether data is encrypted through a confidentiality check on the preprocessed unit test case (not shown).

In addition, the step of performing the first security policy test (not shown), the step of performing the second security policy test (not shown), and the step of performing the third security policy test (not shown) may be performed according to a preset order.

Thereafter, the step of generating the second test case which is a data set for testing the function of the software system based on the first test case may be performed (S150).

In the step of generating the second test case (S150), the second test case may be generated by manipulating the first test case with a randomly generated data type and value, or the second test case may be generated by combining an unpreprocessed unit test case with the first test case.

Then, the step of detecting vulnerabilities in the software system may be performed by executing the second test case (S170).

The security design flaw detection method of the present invention may be implemented in the form of program instructions that can be executed through various computer components and recorded in a computer-readable recording medium. The computer-readable recording medium may comprise program instructions, data files, data structures, etc. alone or in combination.

Program instructions recorded on the computer-readable recording medium may be those specially designed and configured for the present invention, or those known and usable to those skilled in the art of computer software.

Examples of computer-readable recording medium comprise magnetic media such as hard disks, floppy disks and magnetic tapes, optical recording media such as CD-ROMs and DVDs, magneto-optical media such as floptical disks, and hardware devices specially configured to store and execute program instructions, such as ROM, RAM, flash memory, and the like.

Examples of program instructions include high-level language codes that can be executed by a computer using an interpreter or the like as well as machine language codes such as those produced by a compiler. The hardware device may be configured to act as one or more software modules to perform processing according to the present invention and vice versa.

Although various embodiments of the present invention have been shown and described above, the present invention is not limited to the specific embodiments described above. The present invention can be modified and practiced by those skilled in the technical field to which the present invention pertains without departing from the gist of the present invention claimed in the claims, and these modifications should not be individually understood from the technical spirit or perspective of the present invention.

### REFERENCE NUMERAL

100: security design flaw detection apparatus
110: preprocessing unit
111: crawler
113: classifier
115: parser
130: security policy test unit
131: access control check unit
133: data integrity verification unit
135: data confidentiality unit
150: test case generation unit
151: random generation unit
153: combination generation unit
170: vulnerability detection unit

1. A unit test case-based security design flaw detection method performed in a security design flaw detection apparatus for detecting a security design flaw of a software system, the method comprising:
collecting a unit test case for the software system from an external device and preprocessing the unit test case;
generating a first test case by testing whether the software system violates a security policy using the preprocessed unit test case;
generating a second test case that is a data set for testing a function of the software system based on the first test case; and
detecting a vulnerability of the software system by executing the second test case.

2. The method of claim 1, wherein preprocessing the unit test case comprises,
preprocessing the unit test case by classifying code snippets included in the unit test case, and combining or changing the unit test case based on the classified code snippets.

3. The method of claim 1, wherein generating the first test case comprises,
performing a first security policy test to identify whether authorization is granted through an access control check on the preprocessed unit test case;
performing a second security policy test to identify whether data has been changed or tampered without authorization through an integrity check on the preprocessed unit test case; and
performing a third security policy test to identify whether data is encrypted through a confidentiality check on the preprocessed unit test case.

4. The method of claim 3, wherein the first security policy test, the second security policy test, and the third security policy test are performed according to a preset order.

5. The method of claim 1, wherein generating the second test case comprises,
generating the second test case by manipulating the first test case with a randomly generated data type and value, or
generating the second test case by combining an unpreprocessed unit test case with the first test case.

6. A computer-readable storage medium, storing a computer program for performing the unit test case-based security design flaw detection method according to claim 1.

7. A unit test case-based security design flaw detection apparatus for detecting a security design flaw of a software system, the apparatus comprising:
a preprocessing unit for collecting a unit test case for the software system from an external device and preprocessing the unit test case;
a security policy test unit for generating a first test case by testing whether the software system violates a security policy using the preprocessed unit test case;
a test case generation unit for generating a second test case that is a data set for testing a function of the software system based on the first test case; and
a vulnerability detection unit for detecting a vulnerability of the software system by executing the second test case.

8. The apparatus of claim 7, wherein the preprocessing unit preprocesses the unit test case by classifying code snippets included in the unit test case, and combining or changing the unit test case based on the classified code snippets.

9. The apparatus of claim 7, wherein the security policy test unit comprises,
an access control check unit for performing a first security policy test to identify whether authorization is granted through an access control check on the preprocessed unit test case;
a data integrity verification unit for performing a second security policy test to identify whether data has been changed or tampered without authorization through an integrity check on the preprocessed unit test case; and
a data confidentiality unit for performing a third security policy test to identify whether data is encrypted through a confidentiality check on the preprocessed unit test case.

10. The apparatus of claim 9, wherein the first security policy test, the second security policy test, and the third security policy test are performed according to a preset order.

11. The apparatus of claim 7, wherein the test case generation unit comprises,
a random generation unit for generating the second test case by manipulating the first test case with a randomly generated data type and value; and
a combination generation unit for generating the second test case by combining an unpreprocessed unit test case with the first test case.
